(19) United States
(12) Patent Application Publication
(10) Pub. No.: US 2005/0104771 A1
(43) Pub. Date: May 19, 2005

(54) Airborne imaging spectrometry system and method

(75) Inventors: Benjamin Scott Terry, Greenville, SC (US); David R. Flanders, Pottstown, PA (US)

Correspondence Address: DORITY & MANNING, P.A., POST OFFICE BOX 1449, GREENVILLE, SC, 29602-1449, US

(73) Assignee: SpectroTech, Inc.

(21) Appl. No.: 10/943,773

(22) Filed: Sep. 17, 2004

Related U.S. Application Data
(60) Provisional application No. 60/504,574, filed on Sep. 17, 2003.

(51) Int. Cl. G01S 13/00

(52) U.S. Cl. 342/195

(57) ABSTRACT

The present invention generally relates to an airborne imaging spectrometry method and system. According to the present invention, a digital airborne imaging spectrometer is provided aboard an aircraft and is used to collect hyperspectral imagery of an area of interest while the aircraft flies over the area of interest. The method and system of the present invention combine (1) real-time display, aboard an aircraft, of the hyperspectral imagery being collected for an area of interest below the aircraft with (2) transmission of such hyperspectral imagery to a remote location, wherein such imagery is received at the remote location in near real-time. When hyperspectral imagery and related data are received from the aircraft at the remote location, the transmitted hyperspectral imagery and related data are useful at the remote location in time-sensitive or time-critical decision making. Forest fires, infestations of vegetation, and law enforcement scenarios such as counter-narcotic operations are examples of situations in which time-sensitive or time-critical decision making may be necessary and in which the airborne imaging spectrometry system and method of the present invention may be used.

### CROSS REFERENCE TO RELATED APPLICATIONS

This application claims benefit of U.S. Provisional Patent Application No. 60/504,574, filed Sep. 17, 2003, which is incorporated herein in its entirety by reference thereto.

### BACKGROUND OF THE INVENTION

The present invention relates to a system and method in which a hyperspectral digital airborne imaging spectrometer, aboard an aircraft, collects hyperspectral imagery and related data of an area of interest while flying over that area of interest, wherein the hyperspectral imagery is processed aboard the aircraft and is transmitted to a remote location (such as a ground station) in near real-time for use in time-sensitive or time-critical decision making processes.

Multispectral and hyperspectral digital imaging devices generally record reflected and emitted spectral data through a series of spectral detectors. Multispectral imaging devices typically produce spectral images based on a few relatively broad wavelength bands, while hyperspectral imaging devices, on the other hand, collect spectral image data simultaneously in dozens or even hundreds of narrow, adjacent bands along the electromagnetic spectrum.

Hyperspectral images are generally produced by hyperspectral imaging spectrometers, complex sensors that merge spectroscopic technology with remote imaging of the Earth's surface. A hyperspectral imaging spectrometer may, for example, make spectral measurements of many small patches of the Earth's surface, each of which is represented as a pixel in the hyperspectral image. The size of the ground area represented by a single set of spectral measurements defines the spatial resolution of the spectral image and depends on the design of the sensor as well as the height of the sensor above the Earth's surface.

Users often seek to measure the spectral properties of ground features accurately and precisely, and an airborne hyperspectral imaging spectrometer aids in making such measurements. The hyperspectral images produced by commercially available hyperspectral imaging spectrometers generally provide the fine spectral resolution needed to characterize the spectral properties of ground surface material; however, the volume of data in a single hyperspectral image may seem overwhelming to a user. Thus, finding appropriate tools and approaches for analyzing essential information in a hyperspectral image continues to be an area of active research. Background information on hyperspectral imaging may be found in a publication entitled “Introduction to Hyperspectral Imaging,” published by MicroImages, Inc. of Lincoln, Nebr., which is incorporated herein in its entirety by reference thereto.

The use of airborne imaging spectrometers in remote sensing operations is evolving continuously as a means to study the Earth's surface from above. For example, known airborne imaging spectrometers have been used in applications such as detecting and mapping vegetative stress, mapping a geographic area's natural resource composition, monitoring changes in a coastal zone environment, thermally mapping a river basin, monitoring counter-narcotic operations and other law enforcement operations, and identifying and assessing wetlands conditions. In known airborne imaging spectrometry systems, the spectral data collected during a particular airborne mission is processed later, after completion of the particular airborne mission, to produce pictorial mosaics that may be used in environmental monitoring and risk assessments, natural resource management and exploration, and defense and security operations.

Remote sensing in which an airborne imaging spectrometer is employed has been used in applications such as exploration for minerals, precious metals, and petroleum. Aircraft missions are flown over geological structures, and multispectral or hyperspectral image scanners are used to gather spectral data. Such spectral data is processed and certain spectral signatures are assigned to rock formations, which may be potential sites for desired commercial products.

However, the time between gathering the spectral data and the final analysis of such data may be quite lengthy because of the high volume of spectral data collected and/or because of limitations of the technology available for transmitting and analyzing such spectral data (limitations such as a lack of bandwidth for transmitting spectral data from an aircraft to a remote location). By way of example, a year may elapse to convert certain spectral data to a usable product that aids a user in making decisions about an area's potential for minerals, precious metals, oil, or the like. However, because geological structures encounter virtually no change within the time frame of this spectral analysis, time has not been a critical parameter in such geological applications.

Remote sensing employing an airborne imaging spectrometer has also been used to study urban growth and related effects on the environment. Many such studies combine imagery obtained through airborne remote sensing with satellite imagery. Because urban growth and its effects on the environment are slow processes, the large amount of time between the gathering of the spectral data and the analysis of such data has not been of importance.

Additionally, the study of forests using airborne remote sensing devices has been a priority of forestry services, the pulp and paper industries, and others. For example, forestry services and/or industries have used airborne remote sensing devices to collect spectral data and assess changes in forests, changes in forest fire fuel loading, environmental effects due to climatic conditions, culling practices, new growth health, and so forth. Yet, like several applications described above, it has not been a critical factor in such forestry applications that the amount of time required between gathering spectral data and analyzing such data (before the data is useful in forestry decision making) can be quite large.

The applications discussed directly above include just a few scenarios in which the information collected by airborne imaging spectrometry systems may be useful for later decision making. In the above-described applications, the amount of time necessary to transmit the spectral data to a remote location and to produce a pictorial product from the spectral data is not a critical consideration. Thus, known airborne imaging spectrometers and systems may be capable of producing information from spectral data that is useful in situations like those described above.

Airborne imaging spectrometers have been described in various patents and publications. For example, U.S. Pat. Nos. 5,149,959 and 5,276,321 describe an airborne multiband or multichannel imaging spectrometer that is used in conducting airborne geological, geophysical, and environmental surveys in a moving aircraft. The U.S. Pat. Nos. 5,149,959 and 5,276,321 patents are incorporated herein in their entirety by reference thereto. Yet, the spectrometer disclosed by the U.S. Pat. Nos. 5,149,959 and 5,276,321 patents is not designed to collect, process, and transmit, in “near real-time,” spectral imagery and data that is useful immediately in time-sensitive or time-critical decision making.

As used herein, the term “real-time” generally means that no “lag” time or processing time is required. In other words, if an airborne imaging spectrometer includes a display (like a “waterfall”-type display) that allows a user aboard the aircraft to view spectral imagery of a particular ground area immediately while the aircraft is flying over that particular ground area, this would constitute “real-time” display of the spectral imagery related to that particular ground area. The spectrometer, the display, and any related components would be processing the incoming spectral data so quickly that the user aboard the aircraft perceives no delay between flying over the particular ground area, collecting spectral data for that ground area, and seeing the pictorial, spectral images of that ground area on the “waterfall” display screen.

In contrast, the term “near real-time” is used herein to refer to a measure of time in which the present inventors seek to collect, geo-locate, process, and transmit hyperspectral imagery and related data from an aircraft (and its “real-time,” waterfall-type display) all the way to a remote location (e.g., a ground station or another aircraft) so that hyperspectral imagery (and related data) (1) is transmitted from the aircraft to the remote location without the need to land the aircraft and perform additional data processing and (2) is immediately useful to personnel at the remote location in time-sensitive or time-critical decision making.

Significant needs exist for an airborne imaging spectrometry system and method of using the same, wherein the system is capable of transmitting hyperspectral imagery and related data to a remote location in situations where time is a critical parameter (or in “near real-time”). More particularly, a need exists for an airborne imaging spectrometry system that is able to collect, process, geo-locate, analyze, and transmit time-critical hyperspectral imagery and related data, all while an aircraft is conducting an airborne mission. The system and method of the present invention seek to address these and other needs.

Many time-sensitive or time-critical applications exist in which spectral data is needed at a location remote from an airborne imaging spectrometry system. One such application is forest firefighting. Each year, millions of acres of forests are destroyed in forest fires. Forest firefighters use a number of methods to abate the spread of forest fires. For example, forest firefighters may use visual airborne surveillance systems to direct the application of fire retardant chemicals and/or water by airborne tankers to strategic locations within the fire zone.

The goals when using such visual airborne surveillance systems are to observe the forest fire by flying above it and to visually identify what appears to be a “hot spot” or a critical burn area in which the fire intensity is highest. Such information is relayed to the personnel in charge of firefighting assets for action. However, one problem with such an approach is that only a visual observation is conducted, which may or may not correctly identify the most critical burn areas of the forest fire. Additionally, forest firefighters may supplement such visual airborne surveillance systems by taking satellite photographs of the burn area during a forest fire. But for such satellite photography to be processed into useful information for forest firefighters, typically a large amount of time (e.g., 12 hours or more in certain situations) is required.

Thus, a need exists for an airborne imaging spectrometry system that is capable of (1) assessing a forest fire from far above the flames using thermal remote sensing through hyperspectral imaging, and (2) immediately transmitting information (e.g., a thermal mosaic of the forest fire area) in “near real-time” to either a ground station or an airborne tanker for effective fire retardant application. The system and method of the present invention address these and other needs.

Additionally, the destruction of forests by insects presents a significant economic problem to the lumber industry, wood products industry, and the pulp and paper industry, and often such infestations are time-sensitive or time-critical. By way of example, southern pine beetles can infect and kill pine trees in only a matter of weeks. In order to eradicate such infestations, dead trees are cut out, often along with a large zone of seemingly healthy, uninfected trees because the extent of the infestation is not always known and a larger zone is included only for prophylactic purposes. Clear cutting is often recommended.

The use of remote sensing employing an airborne, hyperspectral imaging spectrometry system may be helpful, then, in identifying those trees actually distressed by infestation, since distressed vegetation has a unique spectral signature compared to healthy vegetation. However, when using currently available airborne spectrometers in such situations, acquiring the necessary spectral data and converting this data into spectral signature profiles for the vegetation is a lengthy process. During the time needed for data conversion and analysis, additional trees may become distressed. Moreover, verification of accurate culling of infested trees would be useful, and more economical, while logging crews and their equipment have been mobilized to a site. Therefore, a need exists for an airborne imaging spectrometry system that is capable of (1) identifying and geo-locating those trees that are distressed (for example, by a beetle infestation) using remote sensing through hyperspectral imaging, and (2) immediately transmitting spectral information to the ground so that distressed trees can be cut out before the infestation spreads to other, healthy trees. The method and system of the present invention address these and other needs.

Moreover, security, defense, and law enforcement applications would benefit from remote sensing systems in which an improved airborne, hyperspectral imaging spectrometry system is employed. By way of example, the frequency of drug smuggling into the United States has increased in recent years, and speedboats are often used as the smuggling vehicles. Typically, such speedboats may be 35-40 feet long with large twin engines, and smugglers often travel at night and stop during the day.

Airborne remote sensors, more specifically airborne thermal scanners, have been used to detect heat emitted from the engines of such boats. For example, a known digital airborne imaging scanner has been used to detect not only the heat from a boat's engine(s) but also over 18 miles of propeller wash behind the boat. Such a study showed that a small boat could leave a very large thermal footprint.

However, using a known digital airborne imaging scanner to collect this thermal data requires a significant amount of time for converting the data to usable information for drug interdiction. In addition, the sensitivity of certain scanners (e.g., the signal to noise ratio) may not be adequate for profiling spectral signatures in order to distinguish the propeller wash of different types of boats. Therefore, a need exists for an improved airborne hyperspectral imaging spectrometry system with greater signal to noise ratio and with the capability of providing “near real-time” transmission and analysis of hyperspectral data (e.g., data about the origin, destination, location, direction, and type of boat) for use by authorities in drug enforcement/interdiction endeavors.

The present invention addresses these and other needs by providing a system and method in which a hyperspectral digital airborne imaging spectrometer, aboard an aircraft, collects hyperspectral imagery and related data for an area of interest while the aircraft flies over that area of interest, wherein the hyperspectral imagery (and related data) is geo-located and processed aboard the aircraft and is transmitted to a remote location in near real-time for use in time-sensitive or time-critical decision making processes.

### BRIEF SUMMARY OF THE INVENTION

In response to the described problems and difficulties encountered before, a new airborne imaging spectrometry system and method have been discovered.

According to the present invention, a method of collecting spectral imagery and transmitting such imagery to a remote location is provided. In this method, a digital hyperspectral imaging spectrometer is provided, and the spectrometer is carried by an aircraft. The aircraft is disposed above an area of interest. The area of interest could be, for example, an area affected by a forest fire. Additionally, the aircraft may be disposed directly above the area of interest or at some oblique angle relative to the area of interest.

Hyperspectral imagery of the area of interest is collected with the spectrometer. This imagery is geo-located and is transmitted to the remote location. The geo-located imagery is received at the remote location in near real-time for time-sensitive decision making. Such time-sensitive decision making may include, for example, decision making concerning a forest fire, an area of vegetation affected by infestation, or a law enforcement, security, or defense-related situation (e.g., a counter-narcotics operation), and so forth.

The present invention further provides a method of collecting spectral imagery and transmitting this imagery to a remote location for use in time-sensitive decision making. In this method, a digital hyperspectral imaging spectrometer is provided, which is carried by an aircraft. Further, a display is provided with the aircraft, and the display is in communication with the spectrometer. A navigational system is also provided with the aircraft, and the navigational system includes a global positioning system.

In this method, the aircraft is disposed above an area of interest, and hyperspectral imagery of the area of interest is collected with the spectrometer. This hyperspectral imagery of the area of interest is displayed in real-time on the display. Further, at least one portion of the displayed hyperspectral imagery of the area of interest is selected for a snapshot. As used herein, the term “snapshot” generally refers to a point-in-time view of the displayed hyperspectral imagery.

At least one snapshot of the displayed imagery of the area of interest is created, and this snapshot is geo-located using the navigational system. The geo-located snapshot is transmitted to the remote location, and the geo-located snapshot is received at the remote location in near real-time.

The present invention also relates to an airborne hyperspectral imaging spectrometry system. The system comprises an airborne digital hyperspectral imaging spectrometer that is operative to scan an area of interest and collect hyperspectral imagery of that area of interest. The system further includes a display that is operative to display the hyperspectral imagery of the area of interest in real-time. The system also includes a controller that is operative to create a snapshot of the hyperspectral imagery of the area of interest. This controller is also able to save the snapshot and geo-locate the snapshot.

In this system, there is also provided a transmitter that is operative to transmit the geo-located snapshot to a remote location. The system also includes a receiver at the remote location that is operative to receive the geo-located snapshot in near-real time.

The present invention further provides a geo-located snapshot of an area of interest. This geo-located snapshot is produced by a process during which a digital hyperspectral imaging spectrometer is provided, wherein the spectrometer is carried by an aircraft. This aircraft is disposed above an area of interest, and hyperspectral imagery of the area of interest is collected with the spectrometer. This imagery is geo-located and is then transmitted to a remote location, wherein the geo-located imagery is received at the remote location in near real-time. A geo-located snapshot is produced from this imagery.

It is an object of the present invention to provide an airborne imaging spectrometry system and method, wherein hyperspectral imagery is collected during an airborne mission and transmitted to a location remote from the aircraft in near real-time for use in time-sensitive or time-critical decision making without the need to land the aircraft and further process the hyperspectral imagery before it is useful in time-critical decision making.

Additional objects and advantages of the invention will be set forth in the following description or may be obvious from the description. Structural and operational details of preferred designs of the present invention and components embodying the invention and advantages obtained thereby will become apparent from the appended drawings and the detailed description to follow.

### BRIEF DESCRIPTION OF THE DRAWINGS

The details of the present invention can be understood in reference to the accompanying drawings, in which like reference numbers refer to like parts. It should be noted that the drawings may not be to scale in all instances, but instead may have exaggerated dimensions in some respects to illustrate the principles of the invention.

FIG. 1 provides a block diagram illustrating features of the airborne imaging spectrometry system and method in accordance with an exemplary embodiment of the present invention;

FIG. 2 depicts a “print screen” view of the hyperspectral imagery and related data shown on an airborne display in certain exemplary embodiments of the present invention;

FIGS. 3A and 3B provide gray-scale thermal images of a fire area obtained when demonstrating an exemplary embodiment of the airborne imaging spectrometry system and method of the present invention;

FIG. 4 provides a gray-scale thermal image of a fire area obtained when demonstrating an exemplary embodiment of the system and method of the present invention;

FIG. 5 depicts a snapshot image of a known area used in calibration according to an exemplary embodiment of the present invention;

FIGS. 6A, 6B, and 6C provide hyperspectral imagery of a fire area, wherein the imagery has been processed to varying degrees according to certain exemplary embodiments of the present invention; and

FIGS. 7A and 7B depict hyperspectral imagery of a fire area, wherein the imagery has been processed according to certain exemplary embodiments of the present invention.

### DETAILED DESCRIPTION OF THE INVENTION

A full and enabling disclosure of the present invention, including the best mode contemplated by the inventors of carrying out their invention, is set forth herein. Reference will be made in detail to the presently preferred embodiments of the invention, one or more examples of which are illustrated in the drawings. Each example is provided by way of explanation of the invention, and is not meant as a limitation of the invention. For example, features illustrated or described as part of one embodiment may be used in another embodiment to yield a still further embodiment. It is intended that the present application include such modifications and variations as come within the scope and spirit of the invention. Repeat use of reference characters throughout the present specification and appended drawings is intended to represent the same or analogous features, elements, or components.

Embodiments of the method and system of the present invention are particularly useful in situations wherein time-sensitive or time-critical decision making is necessary. Such situations may include, by way of example, forest fires, infestations of vegetation, law enforcement, security, and/or defense operations, and the like. The airborne imaging spectrometry system and method of the present invention generally combine aspects of (1) being aboard an aircraft and monitoring, in real-time, an event or a condition below by collecting hyperspectral imagery of that event or condition below while the aircraft flies over an area of interest and (2) transmitting one or more snapshots of the hyperspectral imagery of that event or condition, along with related data, to a remote location in near real-time. The present system and method, then, allow a user at the remote location (e.g., a ground receiving station) to use the transmitted imagery and data in time-sensitive or time-critical decision making.

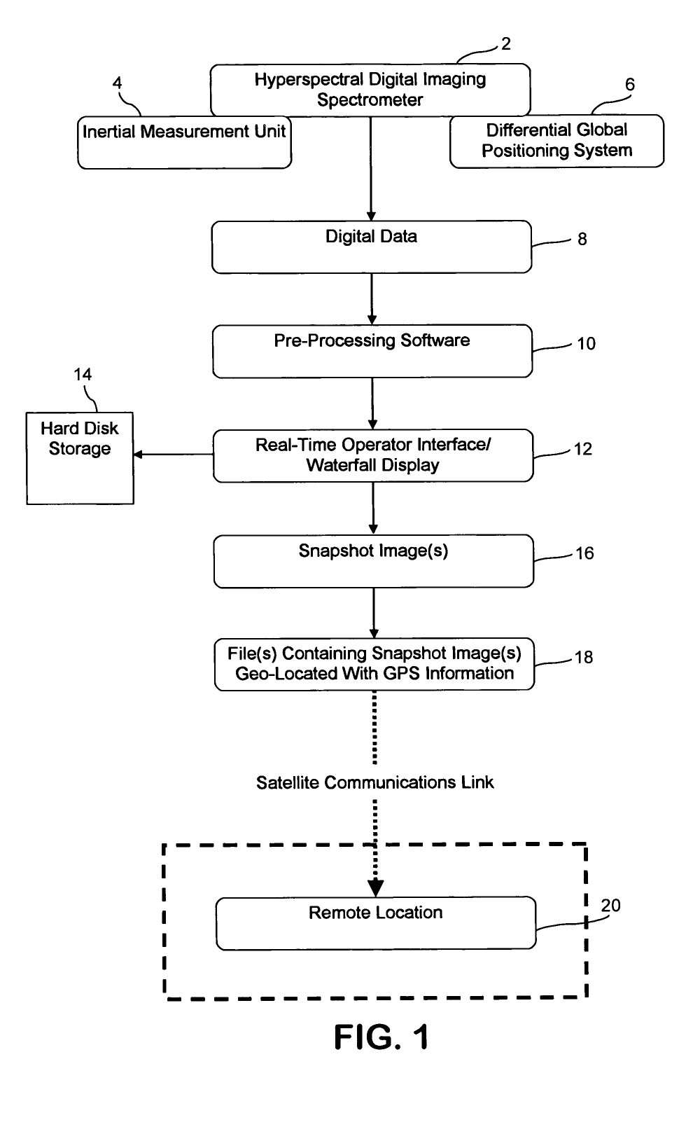

With reference to FIG. 1, a block diagram is provided that illustrates features of the airborne imaging spectrometry system and method according to an exemplary embodiment of the present invention. A hyperspectral digital imaging spectrometer 2 is provided aboard an aircraft. Spectrometer 2 is capable of hyperspectral imaging, imaging that is well beyond the visible portion of the electromagnetic spectrum. For instance, in certain embodiments, spectrometer 2 may be capable of hyperspectral imaging throughout a broad range of electromagnetic spectral wavelengths, more particularly, throughout a range of from about 400 nm to about 12,000 nm.

The hyperspectral digital imaging spectrometer used in certain embodiments of the present invention comprises a scanner module, based on a Kennedy scanner, and a spectrometer module. The spectrometer divides the energy from a pixel on the ground into its spectral components and further transforms that energy into an electronic signal. Digital imaging spectrometers useful in the present invention are typically defined by a high signal to noise ratio. For example, in certain embodiments, the hyperspectral digital imaging spectrometer may have a signal to noise ratio of about 300:1.

Any type of aircraft can be used in the method and system of the present invention. Additionally, the airborne missions for collecting hyperspectral imagery of an area of interest can be flown at a wide range of altitudes.

In some embodiments of the present invention, an integrated navigational and communications system is embedded into the hyperspectral digital imaging spectrometer. In other embodiments, an integrated navigational and communications system need not be embedded into the imaging spectrometer because the aircraft itself may be equipped with such a system.

In certain embodiments of the present invention, the integrated navigational and communications system includes an inertial measurement unit (IMU) 4 and a differential global positioning system (DGPS) 6. Generally, DGPS is a technique for improving GPS accuracy, wherein GPS error is reduced by determining the GPS error at a known location and then subtracting that error from the position at an unknown location. Typically, DGPS systems like DGPS 6 provide accurate and precise GPS information for a location when used in ground-based applications. However, because the method and system of the present invention are used aboard a moving aircraft, IMU 4 is needed to account for the curvature of the Earth, the aircraft's altitude, and aircraft roll, pitch, and yaw. The combination of IMU 4 and DGPS 6 allow hyperspectral imagery to be geo-located or geo-referenced for ground location with a high degree of horizontal accuracy by accounting for the 3-axis movement of the aircraft.

Hyperspectral digital imaging spectrometer 2 collects digital data 8. For example, if spectrometer 2 includes a line scanner as part of its scanner module, the line scanner collects lines of digital data 8 (e.g., data that is typically represented by two digits, 0 or 1) that are not yet in the form of an image. Thus, pre-processing software 10 is employed to format digital data 8 into imagery that is viewable (e.g., imagery of a forest fire below when the aircraft is flying over a forest fire-stricken area).

Once digital data 8 is formatted by pre-processing software 10 and is rendered viewable, the hyperspectral imagery is displayed on a real-time operator interface/waterfall display 12 aboard the aircraft. Generally, the term “interface” is used herein to refer to a means by which a user directs the action of particular software and receives output from that software.

In certain embodiments, interface/display 12 comprises a laptop computer. Operator interface/waterfall display 12 allows the hyperspectral imagery and its related data (1) to be recorded onto hard disk storage 14 for analysis and replay after the airborne mission is completed and (2) to be viewed, in real-time, by a user aboard the aircraft. Additionally, operator interface/waterfall display 12 allows the user to input certain information, such as changes in data collection parameters, aboard calibration information, and information to be used in system troubleshooting. In preferred embodiments, operator interface/waterfall display 12 is based on a laptop computer and may accommodate, in certain embodiments, about 1.3 TB of data movement through the system.

In various embodiments of the present invention, the combination of spectrometer 2 and interface/display 12 includes analytical software that aids in the real-time display of the hyperspectral imagery as well as the analysis of such imagery while aboard the aircraft during an airborne mission. Such analytical software may include, in some embodiments, one or more spectral libraries. Generally, a spectral library is a database that contains spectral signatures or spectral fingerprints for specific features of the area of interest (e.g., the spectral signature for a particular kind of plant that a user is looking for in an area of interest when flying over that area of interest). Thus, such a spectral library may be useful for comparison and matching of hyperspectral imagery and data collected during the particular airborne mission.

A user aboard the aircraft monitors the real-time operator interface/waterfall display 12 and the real-time hyperspectral imagery of an area below that is appearing, in waterfall-like manner, on display 12 as the aircraft flies over the area of interest below. While monitoring the display, the user watches for particular features of interest, for example, what appears to be a “hot spot” or a critical burn area in a forest fire. When the user determines, for example, that for purposes of the particular mission the hyperspectral imagery shown on display 12 should be transmitted to a remote location (e.g., thermal imagery on display 12 may show the hottest areas of the forest fire being monitored by a user), the user makes one or more snapshot images 16 of the imagery shown on display 12.

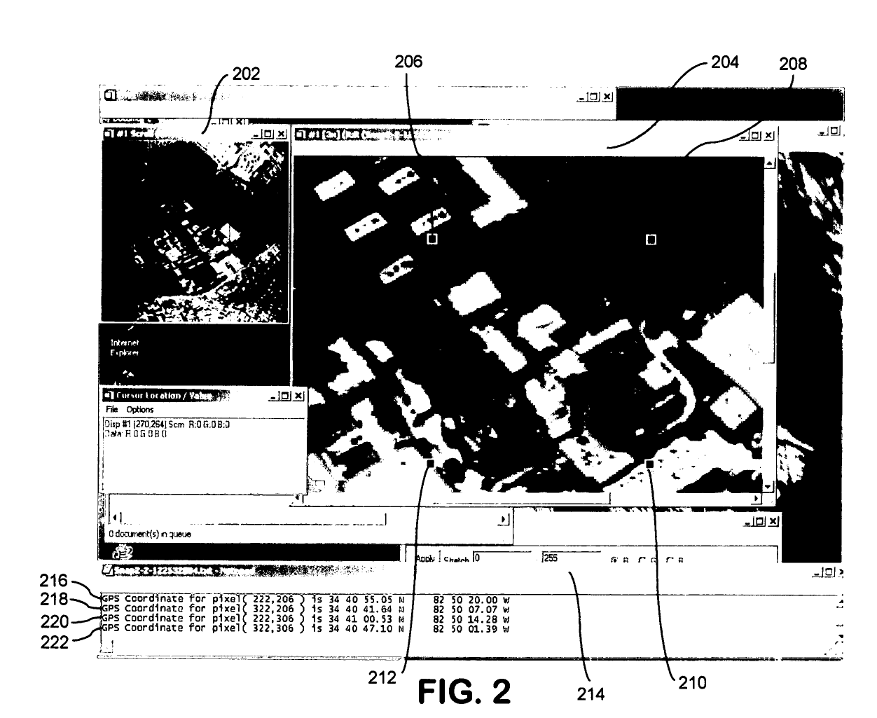

FIG. 2 depicts an example of a “print screen” view of hyperspectral imagery and related data that a user of the present system and method may view, aboard an aircraft, when monitoring interface/display 12 and making a snapshot image 16. Particularly, in FIG. 2, there is shown waterfall display window 202, which contains the “real-time” hyperspectral imagery of the area of interest over which the aircraft is flying. FIG. 2 also includes snapshot image display window 204, wherein a user has controlled the spectrometry system to make a snapshot image of a particular area of interest.

Indicators 206, 208, 210, and 212 are included inside snapshot image display window 204 and are used in geo-referencing or geo-locating the imagery contained within the rectangular shape formed by indicators 206, 208, 210, and 212. More specifically, by employing the DGPS and the IMU, the latitudinal and longitudinal coordinates of indicators 206, 208, 210, and 212 are determined by the system, are inserted into a text file, and are displayed, in this embodiment, in a separate window 214 on the display screen. Within window 214, the first set of GPS coordinates 216 (34 40 55.05 N, 82 50 20.00 W) denotes the location of indicator 206, while the second, third, and fourth sets of GPS coordinates (218, 220, and 222) denote the locations of indicators 208, 210, and 212, respectively.

Returning to the block diagram of FIG. 1, a user saves one or more snapshot images 16 (like the image inside snapshot image display window 204 in FIG. 2) along with each snapshot image's corresponding GPS information into one or more files 18 for transmission. Subsequently, the file(s) 18 are transmitted to remote location 20. In some embodiments, file(s) 18 are transmitted directly to remote location 20.

In other embodiments of the present invention, file(s) 18 are transmitted to remote location 20 via a satellite communications link. In such embodiments, the equipment necessary to establish a satellite communications link is provided aboard the aircraft. File(s) 18 may vary widely in size. In some embodiments of the present invention, for instance, the size of file(s) 18 may be from about 10 MB to about 50 MB.

The size of file(s) 18 to be transmitted to remote location 20 is limited only by the bandwidth available to the user aboard the aircraft. For example, using a standard, commercially available satellite Internet connection may, in some embodiments, limit the size of file(s) 18 to a range of about 10-50 MB. However, in embodiments where a user has access to a communications link providing more bandwidth than such a standard, commercially available satellite Internet connection, the size of file(s) 18 may be immaterial, and file(s) 18 may be much larger than 10-50 MB.

As stated before, remote location 20 may be, for example, a ground receiving station, another aircraft, a boat, or the like, where the information contained in file(s) 18 and received at remote location 20 is useful in time-sensitive or time-critical decision making. Generally, the system and method of the present invention are designed to enhance the capabilities of digital airborne imaging spectrometry systems so that hyperspectral imagery and related data (e.g., GPS data) can be transmitted to remote location 20 from the aircraft in near real-time for use in time-sensitive or time-critical decision making.

As mentioned, the operator interface/waterfall display 12 used in the present method and system displays the spectrometer's hyperspectral imagery data in real-time using a waterfall-type display. In certain embodiments, interface/display 12 includes a personal computer with suitable performance to display the real-time data stream from the imaging spectrometer. Such a personal computer may be connected to the spectrometer using a standard 10BaseT network connection.

The waterfall display presents a waterfall-like image of the area over which the aircraft is flying, and the image contains data from up to three channels of the multichannel hyperspectral digital airborne imaging spectrometer. In certain embodiments of the present invention, the image presented on the waterfall display is only “baseline corrected,” in which the digital data collected by the spectrometer is merely formatted into an image and the image is not corrected for roll, pitch, and yaw or panoramic corrections in order to save processing time.

In certain embodiments, the waterfall display presents a box that contains current GPS values for latitude, longitude, “Altitude ASL” (Above Sea Level), as reported by the DGPS. Additionally, the waterfall display may present a box containing the current scan rate, which is calculated based upon the rate at which spectral data is being received from the scanner module of the spectrometer.

The operator aboard the aircraft is able to manipulate and control the waterfall display in several ways. For instance, in some embodiments, the interface/display is provided with a “Rescale” control button, which can be used to calculate and apply a contrast-enhancing algorithm to the spectrometer's image data being displayed. This “Rescale” control button may be a simple button, wherein no slider controls are necessary.

Additionally, in some embodiments, the interface/display may be provided with a “Baseline” control button, which turns on and off the baseline corrections being applied to the imagery presented on the screen. Further, the interface/display may be provided with an “Altitude AGL” (Above Ground Level) box that allows the operator to enter the current AGL altitude. The AGL altitude may be needed for later calculating the GPS latitude and longitude for each pixel in the snapshot window. Moreover, the interface/display may be provided with a “Band Select” pulldown menu, which is used to select which band(s) of the electromagnetic spectrum are currently being displayed on the waterfall display.

The operator aboard the aircraft monitors the interface/display and decides upon features viewed in the real-time imagery seen on the waterfall display. For example, an operator aboard an aircraft flying over a forest fire may see areas of relatively high temperature in the thermal imagery displayed on the waterfall display, when hyperspectral imaging is taking place in a thermal band along the electromagnetic spectrum.

As previously mentioned, when the operator aboard the aircraft sees a feature of interest (e.g., an area of relatively high temperature), the user makes a snapshot of the area. This snapshot has two purposes: (1) the snapshot optionally may be stored to hard disk for later, off-line retrieval; and (2) the snapshot provides the operator a way to quickly display a calculated GPS latitude and longitude value for any pixel within the snapshot image.

In certain embodiments of the present invention, the interface/display is provided with a “snapshot” control, which the operator aboard the aircraft uses to open and display a snapshot window on the display. The snapshot window (such as snapshot window 204 in FIG. 2) presents to the operator a snapshot of the latest hyperspectral imagery data. In some embodiments, only one snapshot window can be opened by the operator at a time. Additionally, in certain embodiments, new snapshot windows are created in a time period of less than about 2 minutes.

In certain embodiments of the invention, the snapshot image is corrected for roll and for panoramic effects. Additionally, in some embodiments, the operator can select a particular pixel within the snapshot image, and the following values regarding that pixel are displayed: the GPS latitude and longitude coordinates for that pixel; and the “pixel value” (in “counts”). In certain embodiments, the pixels in the snapshot image are geo-located to GPS latitudinal and longitudinal coordinates within 20 meters or less of their actual location.

The snapshot window can be controlled in several ways by the operator aboard the aircraft. Specifically, in certain embodiments, the snapshot window includes an Altitude AGL box. Initially, when the operator first creates the snapshot window, this box contains the same value present in the Altitude AGL box present in the waterfall display window. The Altitude AGL box in the snapshot window allows the operator to re-enter a new AGL altitude value, in order to re-calculate the GPS latitude and longitude values after a snapshot has been taken (in case the waterfall display window's AGL altitude value is incorrect). Such re-calculation may be accomplished using a “Recalc GPS” button, which re-calculates GPS values for each pixel of the snapshot image, in case the value in the “Altitude AGL” box in the snapshot window is different from the waterfall display window's AGL altitude value. Essentially, then, the operator may input the current AGL altitude of the aircraft when manipulating the snapshot window so that the actual width of each pixel in the snapshot image may be determined. Additionally, in some embodiments, the interface/display may be equipped with a “Grab” button, which the operator can use to grab a new sample of waterfall display data to be displayed within the window.

In certain preferred embodiments, the interface/display is provided with a “Save” button, which saves the current snapshot image to a file. For example, the current snapshot image may be saved in JPEG format, in Bitmap format, or in .tif format with an associated .tfw world file. As is known in the art, a JPEG (“Joint Photographic Experts Group”) image is derived from a compression technique for color images and photographs that balances compression against loss of detail in the image. In certain preferred embodiments, the snapshot image is saved in JPEG format or in .tif format with an associated .tfw world file.

In some embodiments of the present invention, the GPS information for the snapshot image is also saved to a computer file. For example, the GPS coordinates for four indicators shown on a snapshot image may be saved into a text file that the operator associates with the corresponding saved snapshot image file. For instance, referring to FIG. 2, GPS coordinates 216, 218, 220, and 222 for indicators 206, 208, 210, and 212 were saved in a text file, shown in window 214, which the operator associated with the saved snapshot image file, shown in window 204.

Additionally, in certain embodiments, the interface/display is provided with a “Cancel” button, which closes the snapshot window. Typically, this “Cancel” button has the intended effect of closing the snapshot window regardless of whether or not a new “Grab” is in progress. The “Cancel” button can be used to abort a snapshot operation before it is completed, if this is needed by the operator.

During the period of time that a snapshot image is displayed in a snapshot window, the waterfall window continues to receive and display new hyperspectral imagery data from the spectrometer's scanner. Thus, even when the operator creates a snapshot window, there is no stoppage of the collecting of real-time hyperspectral imagery data.

The airborne imaging spectrometry system and method of the present invention provide various advantages over prior art systems and methods. By employing a hyperspectral digital imaging spectrometer in the present method and system, the imagery that is collected when an aircraft flies over an area of interest goes well beyond imagery that is limited to the visible portions of the electromagnetic spectrum. The present method and system allow for hyperspectral imagery to be collected during an airborne mission, to be transmitted to a remote location, and to be received at the remote location in near real-time so that the imagery and its related data are useful in time-sensitive or time-critical decision making.

The following Examples illustrate several actual demonstrations of the present airborne imaging spectrometry system and method.

### EXAMPLE 1

In this Example, a system according to the present invention was tested to demonstrate the ability of the system to collect hyperspectral imagery and related data during an airborne mission and transmit that imagery and data from the aircraft to a ground receiving station in near-real time. More specifically, the goal of this Example was to demonstrate this near real-time transmission of hyperspectral imagery and data in less than 15 minutes from the time the imagery and related data were collected aboard the aircraft to the time the imagery and data were received at the ground receiving station.

The area of interest in Example 1 was an area in a national forest where the U.S. Forestry Service was conducting controlled burns. Thus, the time-sensitive or time-critical decision making involved in Example 1 included making decisions in a forest firefighting application.

The aircraft in which the digital hyperspectral imaging spectrometer was mounted was a U.S. Forestry Service Beechcraft King Air (C-90B), twin engine, turbo prop aircraft, modified with a 24-inch diameter camera port located in the bottom of the center fuselage of the aircraft. This camera port allowed for an unobstructed 60 degree field of view to the ground below the aircraft. The aircraft was also equipped with autopilot, sufficient power supply, and a Differential Global Positioning System (DGPS).

The hyperspectral spectrometer used in Example 1 was a Digital Airborne Imaging Spectrometer (DAIS) 3715, manufactured by Geophysical & Environmental Research (GER) Corporation of Millbrook, N.Y. The spectrometer includes a Kennedy-type, whiskbroom scanner that is able to record 37 channels of spectral data ranging from wavelengths of 400 nm to 12,000 nm along the electromagnetic spectrum. The DAIS 3715 spectrometer provides hyperspectral imagery by using a Kennedy-type scanner to achieve high scan efficiency over a wide field of view. Additionally, the spectrometer is integrated with a C-MIGITS III Inertial Measurement Unit (IMU) for accurate geo-location at 1-meter spatial resolution. The DAIS 3715 spectrometer is described more particularly in the DAIS 3715 Technical Description, dated Mar. 27, 2001, which is incorporated in its entirety herein by reference thereto. Additionally, the DAIS 3715 spectrometer in Example 1 utilized an integrated Sun Microsystems workstation as a data controller and an 8 mm Exobyte tape drive for high-speed recording of the spectral data.

When mounting the DAIS 3715 spectrometer aboard the aircraft, several measurements of the aircraft fuselage were taken to ensure that the spectrometer could be mounted properly inside the aircraft. These measurements included cabin width, cabin door height and width, distance between seat tracks on the floor for attachment points, and dimensions of the camera port modification to ensure an appropriate field of view for the spectrometer.

In addition to the spectrometer itself, support equipment for the spectrometer was provided aboard the aircraft. For example, mounting and stabilization hardware for the spectrometer was provided aboard the aircraft as well as consumables for the spectrometer (e.g., liquid nitrogen for cooling the thermal detector of the spectrometer, data recording media, and batteries). Liquid nitrogen was included during Example 1 because inadequate cooling of the thermal detector(s) of the spectrometer impairs the quality of the hyperspectral imagery collected and transmitted to the ground. Additionally, cables, antennae, and wiring harnesses were provided aboard the aircraft so that the spectrometer could be properly interfaced with the integrated communications, data processing, and navigation system aboard the aircraft.

Besides the DAIS 3715 spectrometer and its support equipment, an integrated communications, data processing, and navigation system was provided aboard the U.S. Forestry Service aircraft. This integrated communications, data processing, and navigation system included the following components: one hand-held Global Positioning System (GPS) receiver, commercially available as the Magellan Sport Trak; one iridium satellite telephone; a notebook or laptop personal computer (commercially available from Compaq) equipped with an Intel Celeron processor; internet service, commercially available from Earthlink; and SpectroTech imagery processing software. SpectroTech imagery processing software takes digital data that is received from the DAIS 3715 spectrometer and pre-processes this digital data into viewable imagery. Further, SpectroTech imagery processing software puts this imagery into a format that is compatible with known imagery analysis programs or software.

During the course of Example 1, a ground crew was located at the ground receiving station for receiving the hyperspectral imagery and related data from the airborne system in near real-time. The equipment provided to the ground crew included a personal computer, commercially available from Dell, that was equipped with an Intel Pentium processor. This computer included Microsoft Windows 2000 operating system, which is commercially available from Microsoft. The ground crew was also equipped with an iridium satellite telephone.

The computer software provided to the ground crew included: Internet and e-mail service; SpectroTech imagery processing software (discussed above); ARC View Geographical Information System (GIS) software; and ENVI Imagery Analysis software. ARC View GIS is a commercially available mapping product that may be used to obtain mapping data from imagery such as the hyperspectral imagery collected and transmitted during Example 1. ENVI is a commercially available imagery analysis product, which allows a user to manipulate and analyze imagery such as the hyperspectral imagery collected and transmitted in this Example.

In preparing for the test flights that took place during Example 1, the UNIX code for the Sun workstation that controls the DAIS 3715 spectrometer was modified to allow for the following: (1) a real-time waterfall display for up to three channels of imagery data to be viewed on the laptop computer aboard the aircraft; (2) real-time integration of GPS data to each pixel of the displayed imagery, wherein that GPS data is further refined (to give the precise ground position of each pixel in an image) based on input from the IMU to account for the curvature of the Earth, the aircraft's altitude, and aircraft roll, pitch, and yaw; (3) separation of one scene of imagery data, the “snapshot,” from the waterfall display onto a “split screen” on the airborne laptop computer's screen; and (4) annotation of the snapshot to display four indicators, which are GPS points whose latitudinal and longitudinal coordinates are calculated off of the center pixel of the snapshot.

Additionally, in preparing for the test flights of Example 1, the aircraft's power systems were tested to ensure compatibility with the power requirements of the DAIS 3715 spectrometer. Further, the communication and navigation equipment was tested for functionality and was calibrated, which included an initial flight path over known points so that accuracy of the navigational equipment could be confirmed.

The persons involved in the test flights of Example 1 included: (1) aboard the aircraft—a U.S. Forestry Service pilot; a U.S. Forestry Service observer; an operator for the spectrometry system; and an information technology specialist; and (2) on the ground—a program manager; and an observer. Before conducting the test flights, these crew members discussed issues such as flight path, aircraft maneuvers, altitude, speed, sun angles, and the overall safety of the test flights.

As stated above, the test flights of Example 1 were conducted over controlled burns in a national forest being managed and supervised by U.S. Forestry Service personnel. Thus, the time-sensitive or time-critical decision making in Example 1 addressed forest firefighting applications. The weather during the test flights of Example 1 was warm with light winds, bright sun, and few clouds.

The test flights proceeded above the controlled burn area and continued for approximately one hour. During this time, the flight crew made seven passes over the controlled burn area at altitudes of 1000, 1500, 2000, 2500, and 3000 feet above ground level and at 120 knots indicated air speed. The final two passes over the burn area were conducted at an altitude of 2500 feet above ground level and were for data recording purposes only (without data transmission).

During the first five passes over the burn area, approximately ten snapshots were derived from the real-time display of hyperspectral imagery data. The snapshots were collected as one airborne crew member, the operator for the spectrometry system, recognized areas of extreme heat in the fire area while monitoring the real-time waterfall display of the thermal infrared band of the spectrometer. Specifically, while flying over the fire area, the operator was able to recognize the thermal signature of the fire boundary on the waterfall display.

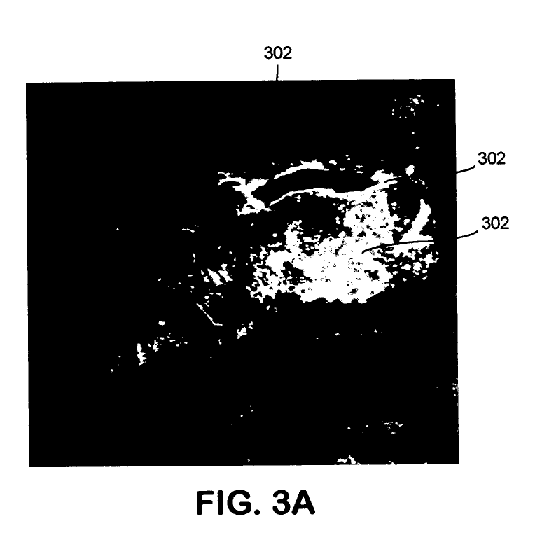

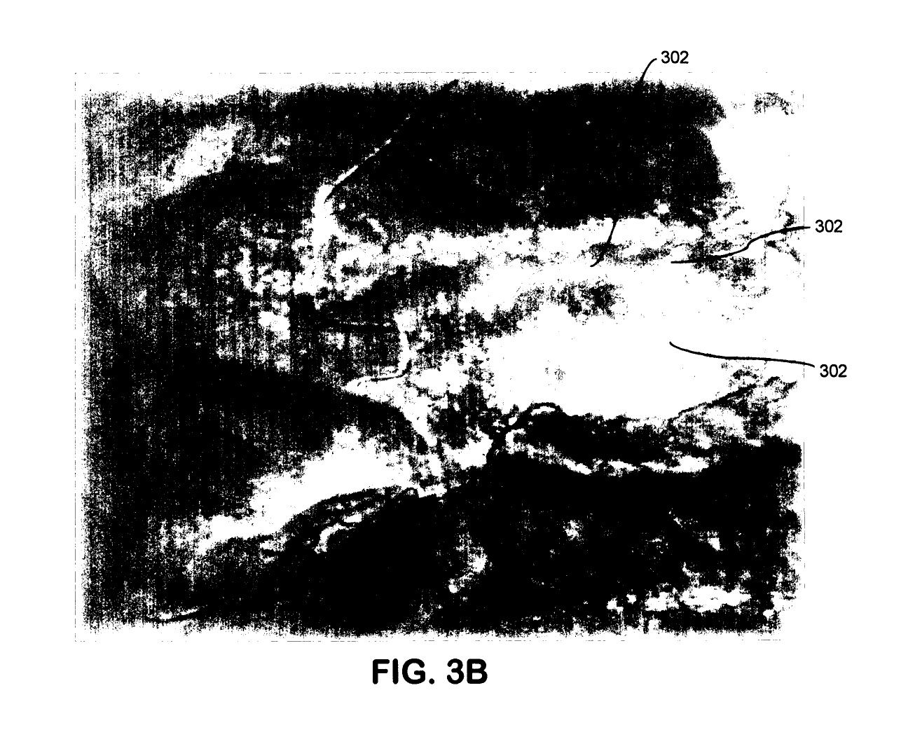

FIG. 3A shows one snapshot image that was taken by the spectrometry system during the test flights of Example 1. FIG. 3A is a gray-scale thermal image of the fire area, and white areas 302 in the upper-right quadrant of the figure constitute areas where the fire is actually located, thereby allowing the user to see the boundaries of the fire. FIG. 3B is another snapshot image taken during the test flights of Example 1, and FIG. 3B includes the same white areas 302, denoting areas of extreme heat where the fire is actually burning.

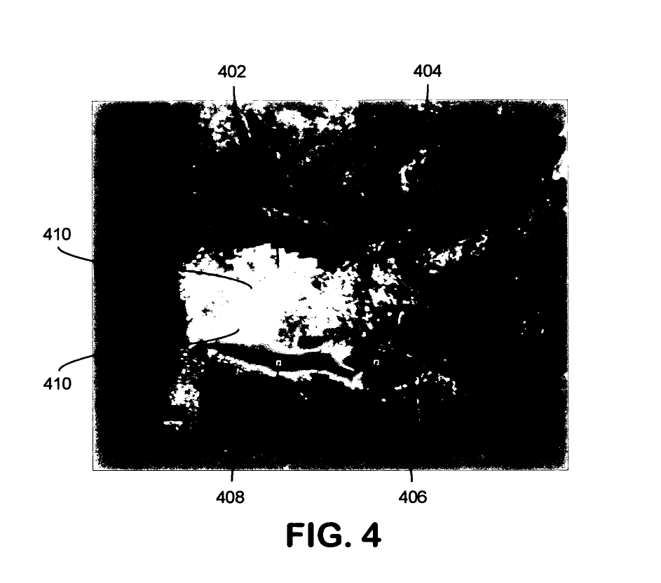

The hyperspectral snapshot images, like those shown in FIGS. 3A and 3B, were each saved as a JPEG image file on the hard drive of the airborne laptop computer, while the corresponding GPS coordinates for each snapshot were saved as a separate text file. FIG. 4 shows another snapshot (a gray-scale thermal image) of the fire area and includes GPS indicators 402, 404, 406, and 408. FIG. 4 also includes white areas 410, denoting areas of extreme heat where the fire is actually burning. When the snapshot shown in FIG. 4 was saved as JPEG image file, at least the GPS coordinates for indicators 402, 404, 406, and 408 were saved as a separate text file that the operator associated with the corresponding JPEG image file.

Each of the file “pairs” saved during the test flights of Example 1 (the JPEG image file of a snapshot along with its corresponding GPS coordinate-containing text file) was attached to an e-mail message and transmitted to the ground station using the Internet connection that was accessed from the aircraft using the iridium satellite telephone. Specifically, a crew member aboard the aircraft dialed into an Earthlink Internet connection using the iridium satellite telephone system provided aboard the aircraft. Each file was transmitted from the aircraft and received by the ground station within ten minutes of data collection, and it was determined that most of the transmission time was due to the actual e-mail transmission.

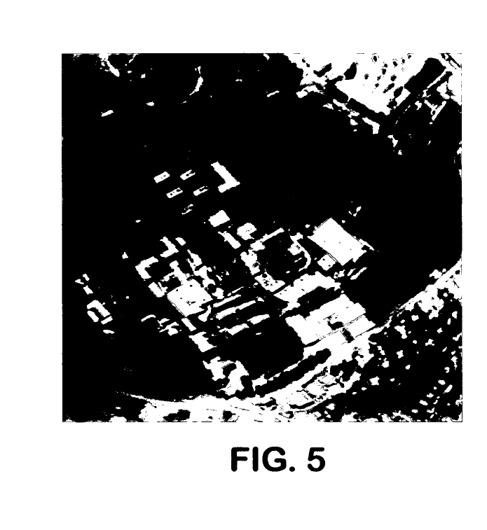

The airborne mission of Example 1 concluded with an additional flight line over a known area (the campus of Clemson University, located in Clemson, S.C.) to provide calibration information for the navigation system. FIG. 5 shows a snapshot (specifically, a thermal image) taken of the Clemson University campus while this last calibration-based flight line was conducted.

The JPEG image files and text files were received by the ground station within ten minutes of data collection. The quality of the images obtained in Example 1 was satisfactory. Specifically, the images showed the boundaries of the fire due to the extreme difference in temperature between the fire and the background. Transmission of the images over the satellite telephone communication link was satisfactory because it resulted in the ground station receiving the imagery within an acceptable time period-here, within less than 15 minutes of data collection.

The usefulness of the imagery, once it is received at the ground station, is measured by the ability of the ground crew to make decisions based on the imagery in a relatively short amount of time. This means that the image file(s) should be in a data format that is easily integrated with whichever geographical information system (GIS) is provided at the ground receiving station.

The text files, which contain GPS information for corresponding snapshots and which are transmitted to the ground receiving station along with the image files, aid in this integration of the image files with the GIS provided at the ground receiving station. As mentioned above, before Example 1 was conducted, the UNIX code for the Sun workstation that controlled the DAIS 3715 spectrometer was modified to incorporate a subroutine that measures the location of the center pixel of a snapshot image based on GPS coordinates and corrected inputs from the IMU. The location data is presented as four square-shaped indicators on the snapshot image, and the GPS coordinates for these four indicators are calculated in relation to the center pixel of the snapshot image. Again, a corresponding text file is simultaneously created, which assigns a latitude and longitude to each of the four indicators. This means that the snapshot imagery has several correctly geo-located points that are visibly present on the snapshot images themselves and that aid the ground crew in further analyzing the received snapshot imagery (e.g., mapping the received snapshot imagery using a GIS).

During Example 1, the ground crew's computer software included the ARC View Geographical Information System (GIS). During post-mission analysis of the hyperspectral imagery obtained during the test flights of Example 1, it was determined that the thermal imagery received from the DAIS 3715 spectrometer could be effectively integrated with this ARC View GIS. Specifically, the post-mission data analyzers on the ground were able to extract the pixels from the thermal snapshot images according to the highest thermal values and overlay those pixels onto an ARC View map.

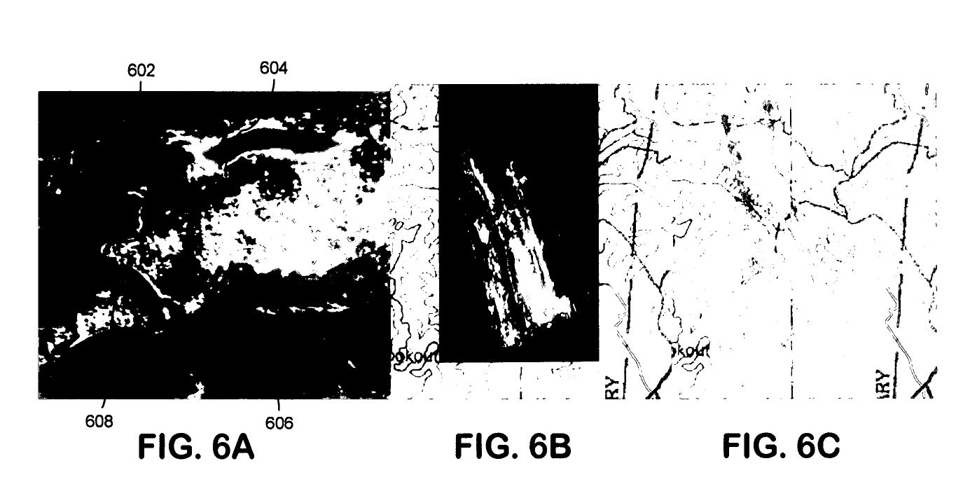

FIGS. 6A, 6B, and 6C illustrate how such post-mission analysis of the spectral data obtained during Example 1 was performed. FIG. 6A is a snapshot, gray-scale thermal image of the fire area that was obtained during the test flights of Example 1. This snapshot was collected, saved, transmitted to the ground receiving station, and received at the ground receiving station within less than 15 minutes (e.g., in near real-time). FIG. 6A includes indicators 602, 604, 606, and 608. A corresponding text file with the GPS coordinates for indicators 602, 604, 606, and 608 was also transmitted to and received by the ground receiving station in near real-time.

Using the ARC View GIS mapping product, the ground crew overlaid the snapshot image shown in FIG. 6A on top of a map of the national forest in which the controlled burns were conducted. Specifically, indicators 602, 604, 606, and 608 from the snapshot image of FIG. 6A were matched up with their actual latitudinal and longitudinal locations on the map of the national forest using the GPS coordinates for these four indicators that were transmitted in the text file. FIG. 6B shows this overlay of the thermal image of FIG. 6A atop a map of the national forest. In creating the overlay shown in FIG. 6B, the ground crew also ortho-rectified the thermal image of FIG. 6A atop the map of the national forest, meaning that the ground crew corrected FIG. 6B by taking into account the elevation or contour of the ground.

In FIG. 6C, there is shown a refined version of the overlay from FIG. 6B. Specifically, in FIG. 6C, using the ARC View GIS software, the ground crew or post-mission data analyzers removed all of the “background” imagery from the original thermal image of FIG. 6A, leaving only the “hot areas” (or the fire-stricken areas) on the overlaid map product of FIG. 6C. Essentially, during this process, the post-mission data analyzers geo-corrected the imagery received from the aircraft using both natural and manmade features visible in the imagery as well as the GPS information contained in the text file to obtain a mapped product of the forest fire with a very small discrepancy in horizontal accuracy (e.g., approximately +/−10 meters). This information shows that by using an airborne imaging spectrometry system and method according to the present invention, critical areas of a forest fire may be pinpointed, for instance, within about 10 meters or less of their actual locations.

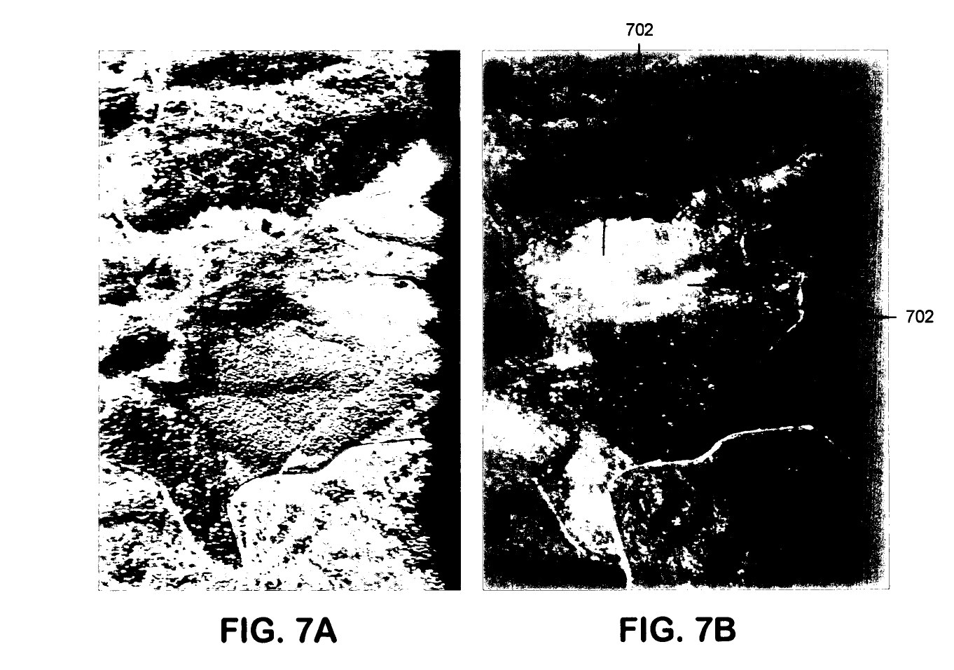

Additional hyperspectral imagery of the fire area that was collected during Example 1, transmitted to the ground receiving station, and processed by the ground crew is shown in FIGS. 7A and 7B. The imagery in FIG. 7A was processed by the post-mission data analyzers so that three bands of the electromagnetic spectrum (bands 18, 6, and 2, three simulated true color bands) are represented; thus, FIG. 7A essentially shows imagery based on reflected light. FIG. 7A does not reveal any indication of a forest fire.

For FIG. 7B, however, the exact same imagery was processed differently so that band 36, a thermal band located at a wavelength range of about 3.0-5.0 microns along the electromagnetic spectrum, was represented; thus, FIG. 7B essentially shows imagery based on emitted energy. In FIG. 7B, white areas 702 clearly denote areas in which the forest fire is located.

In summary, during Example 1, hyperspectral imagery (and related data) was received at the ground receiving station in near real-time and was therefore useful by the firefighting authorities located at the ground station in time-sensitive or time-critical decision making, such as how to allocate the firefighting resources (including aircraft, trucks, personnel, and equipment) in a timely and accurate manner for improved firefighting capabilities. For example, the hyperspectral imagery data received at the ground station provided the firefighting authorities on the ground with accurate information about the location of the forest fire so that firefighters could deliver water and fire retardants to the forest fire effectively and efficiently and could place fire boundaries for seizing and maintaining control of the fire within a reasonable geographic area.

### EXAMPLE 2

In this Example, another airborne mission took place one day after the test flights conducted and described in Example 1 above. Specifically, the test flights in this Example continued for about 1.5 hours, and the same equipment, flight procedures, and methods from Example 1 were used, with the following exceptions: (1) additional liquid nitrogen was provided aboard the aircraft for further cooling of the thermal detectors on the DAIS 3715 spectrometer; (2) a calibration flight was conducted upon departure from the airport area rather than upon return; and (3) the procedures and hardware for installing the DAIS 3715 spectrometer in the aircraft were slightly modified to result in a more secure mounting system in the aircraft. The weather conditions during the test flights of Example 2 were favorable.

The quality of the hyperspectral imagery collected and transmitted during the test flights of Example 2 was excellent and was higher than the quality of some of the imagery collected and transmitted during the test flights of Example 1. Particularly, notable land characteristics and characteristics of the controlled forest fire were readily discernible. However, during Example 2, transmission of the hyperspectral imagery and related data over the satellite telephone communication link was limited due to poor GPS satellite performance on this particular date and time. Specifically, during the test flights of Example 2, even though the same procedure was used for dialing into an Earthlink internet connection using the iridium satellite telephone system, the satellite internet connection dropped off-line before any snapshot could be completely transmitted from the aircraft to the ground station.

It was determined during Example 2 that an alternative data transmission system (for example, one including an FAA-approved permanent antenna installed on top of the aircraft fuselage) may be used in situations where problems are encountered with a satellite telephone communication link.

In short, the description and Examples above illustrate that the airborne imaging spectrometry system and method of the present invention are able to effect successful transmission of airborne hyperspectral imagery (specifically, usable thermal imagery) from an aircraft to a remote location in near real-time (e.g., in some embodiments, in less than 15 minutes from the time of data collection to the time of receipt at the remote location). In accordance with the method and system of the present invention, the transmitted hyperspectral imagery is of good quality and is useful by personnel at the remote location in time-sensitive or time-critical decision making (such as decision making concerning the abatement of a forest fire).

While the particular airborne imaging spectrometry system and method as herein shown and described in detail are fully capable of attaining the objects of the invention, it is to be understood that it is the presently preferred embodiment of the present invention and is thus representative of the subject matter that is broadly contemplated by the present invention. It is to be further understood that the scope of the present invention fully encompasses other embodiments that may become obvious to those skilled in the art. It is intended that the present invention include such modifications and variations as come within the scope of the appended claims and their equivalents, in which reference to an element in the singular is not intended to mean “one and only one” unless explicitly so stated, but rather “one or more.”

1. A method of collecting spectral imagery and transmitting said imagery to a remote location, said method comprising the steps of:
providing a digital hyperspectral imaging spectrometer carried by an aircraft;
disposing said aircraft above an area of interest;
collecting hyperspectral imagery of said area of interest with said spectrometer;
geo-locating said imagery; and
transmitting said geo-located imagery to said remote location, wherein said geo-located imagery is received at said remote location in near real-time for time-sensitive decision making.

2. The method of claim 1, further including providing a display with said aircraft.

3. The method of claim 2, said display in communication with said spectrometer.

4. The method of claim 3, further including providing a computer carried by said aircraft, said display operable with said computer.

5. The method of claim 3, said display in real-time communication with said spectrometer.

6. The method of claim 5, further including the steps of selecting at least one snapshot of said imagery from said display, geo-locating said at least one snapshot, and transmitting said at least one geo-located snapshot remote from said aircraft.

7. The method of claim 1, further including providing a navigational system with said aircraft.

8. The method of claim 7, said navigational system including a global positioning system.

9. The method of claim 8, said navigational system including an inertial measurement unit.

10. The method of claim 1, said geo-located imagery transmitted to said remote location by satellite communication link.

11. The method of claim 1, said spectrometer operable with electromagnetic spectral wavelengths from about 400 nm to about 12,000 nm.

12. The method of claim 1, said geo-locating including providing latitudinal and longitudinal information for said imagery.

13. A method of collecting spectral imagery and transmitting said imagery to a remote location for use in time-sensitive decision making, said method comprising the steps of:
providing a digital hyperspectral imaging spectrometer carried by an aircraft;
providing a display with said aircraft, said display in communication with said spectrometer;
providing a navigational system with said aircraft, said navigational system including a global positioning system;
disposing said aircraft above an area of interest;
collecting hyperspectral imagery of said area of interest with said spectrometer;
displaying said hyperspectral imagery of said area of interest in real-time on said display;
selecting at least one portion of said displayed hyperspectral imagery of said area of interest for a snapshot;
creating at least one snapshot of said at least one portion of said displayed hyperspectral imagery of said area of interest;
geo-locating said at least one snapshot using said navigational system; and
transmitting said at least one geo-located snapshot to said remote location;
wherein said geo-located snapshot is received at said remote location in near real-time.

14. The method of claim 13, said spectrometer capable of imaging electromagnetic spectral wavelengths of about 400 nm to about 12,000 nm.

15. The method of claim 13, said geo-locating of said at least one snapshot including providing latitudinal and longitudinal information for said at least one snapshot.

16. The method of claim 13, wherein said remote location is a second aircraft.

17. The method of claim 13, wherein said remote location is a ground receiving station.

18. The method of claim 13, further including processing said hyperspectral imagery aboard said aircraft, said processing by predetermined criteria.

19. An airborne hyperspectral imaging spectrometry system, comprising:
an airborne digital hyperspectral imaging spectrometer operative to scan an area of interest and collect hyperspectral imagery of said area of interest;
a display operative to display said hyperspectral imagery of said area of interest in real-time;
a controller operative to create a snapshot of said imagery of said area of interest, save said snapshot, and geo-locate said snapshot;
a transmitter operative to transmit said geo-located snapshot to a remote location; and
a receiver at said remote location operative to receive said geo-located snapshot in near-real time.

20. The airborne hyperspectral imaging spectrometry system of claim 19, said spectrometer operative from electromagnetic spectral wavelengths of about 400 nm to about 12,000 nm.

21. The airborne hyperspectral imaging spectrometry system of claim 19, said geo-located snapshot including navigational indicia.

22. An airborne hyperspectral imaging spectrometry system, comprising:
means for scanning an area of interest and collecting digital hyperspectral imagery of said area of interest;
means for displaying said digital hyperspectral imagery of said area of interest in real-time;
means for creating a snapshot of said imagery of said area of interest, saving said snapshot, and geo-locating said snapshot;
means for transmitting said geo-located snapshot to a remote location; and
means for receiving said geo-located snapshot at said remote location in near-real time.

23. The airborne hyperspectral imaging spectrometry system of claim 22, said means for scanning further including means for scanning and collecting imagery from electromagnetic spectral wavelengths of about 400 nm to about 12,000 nm.

24. The airborne hyperspectral imaging spectrometry system of claim 22, said geo-located snapshot including navigational indicia.

25. A geo-located snapshot of an area of interest, said snapshot produced by the process comprising the steps of:
providing a digital hyperspectral imaging spectrometer carried by an aircraft;
disposing said aircraft above an area of interest;
collecting hyperspectral imagery of said area of interest with said spectrometer;
geo-locating said imagery;
transmitting said geo-located imagery to a remote location, wherein said geo-located imagery is received at said remote location in near real-time; and
producing a geo-located snapshot from said imagery.

26. The geo-located snapshot of claim 25, wherein said geo-located imagery is received at said remote location in less than 120 minutes from said step of geo-locating said imagery.

27. The geo-located snapshot of claim 25, wherein said geo-located imagery is received at said remote location in less than 60 minutes from said step of geo-locating said imagery.

28. The geo-located snapshot of claim 25, wherein said geo-located imagery is received at said remote location in less than 30 minutes from said step of geo-locating said imagery.

29. The geo-located snapshot of claim 25, wherein said geo-located imagery is received at said remote location in less than 15 minutes from said step of geo-locating said imagery.

30. The geo-located snapshot of claim 25, wherein said geo-located imagery is received at said remote location in less than 10 minutes from said step of geo-locating said imagery.

31. The geo-located snapshot of claim 25, wherein said hyperspectral imagery is processed aboard said aircraft and before said transmission.
